(19) United States
(12) Patent Application Publication
(10) Pub. No.: US 2025/0216903 A1
(43) Pub. Date: Jul. 3, 2025

(54) CONTROL METHOD AND ELECTRONIC DEVICE

(71) Applicant: Lenovo (Beijing) Limited, Beijing (CN)

(72) Inventors: Xiaofeng ZHU, Beijing (CN); Sanjay DHAR, Algonquin, IL (US)

(21) Appl. No.: 18/883,891

(22) Filed: Sep. 12, 2024

(30) Foreign Application Priority Data
Dec. 29, 2023 (CN) 202311865542.0

(51) Int. Cl. G06F 1/16

(52) U.S. Cl. CPC G06F 1/1652

(57) ABSTRACT

A control method includes: obtaining a configuration parameter in response to a control instruction; and controlling a driver to be in a working state corresponding to the control instruction based on the configuration parameter, the driver being configured to drive a display screen to switch between a first state and a second state based on the configuration parameter being in the working state corresponding to the control instruction; the display screen being in the first state corresponds to a first part of the display screen, and the display screen being in the second state corresponds to a second part of the display screen, the second part including the first part, where the speed represented by the configuration parameter is different, and a time for the display screen to switch between the first state and the second state is different.

### FIELD CROSS-REFERENCE TO RELATED APPLICATION

The present disclosure claims priority to Chinese Patent Application No. CN202311865542.0, filed on Dec. 29, 2023, the entire content of which is incorporated herein by reference.

### FIELD OF TECHNOLOGY

The present disclosure relates to the field of computer technology and, more specifically, to a control method and an electronic device.

### BACKGROUND

To expand the display screens of electronic devices such as mobile phones and tablets, deformable display screens such as rollable screens and foldable screens have emerged and are increasingly used. The deformable display screen is generally folded. When the device screen needs to be expanded, the deformable display screen can be unfolded to expand the display screen area. However, the conventional method of controlling the expansion/contraction of a deformable display screen can only expand/contract at a fixed speed, which affects the user experience.

### SUMMARY

One aspect of this disclosure provides a control method. The control method includes obtaining a configuration parameter in response to a control instruction, and controlling a driver to be in a working state corresponding to the control instruction based on the configuration parameter. The driver is configured to drive a display screen to switch between a first state and a second state based on the configuration parameter being in the working state corresponding to the control instruction. The display screen in the first state corresponds to a first part of the display screen, and the display screen in the second state corresponds to a second part of the display screen, the second part including the first part. The speed represented by the configuration parameter is different, and a time for the display screen to switch between the first state and the second state is different.

Another aspect of this disclosure provides an electronic device. The electronic device includes a deformable display screen, a driver, and a controller. The first state of the deformable display screen corresponds to a first part of the deformable display screen, and a second state of the deformable display screen corresponds to a second part of the deformable display screen, the second part including the first part. The driver is configured to drive the deformable display screen to switch between the first state and the second state. The controller is configured to respond to a control instruction, the control instruction including a configuration parameter indicating speed, and control the driver based on the configuration parameter for the driver to be in a working state based on the configuration parameter. The driver is in the working state based on different configuration parameters, and the deformable display screen is configurated to switch between the first state and the second state at different speeds.

### BRIEF DESCRIPTION OF THE DRAWINGS

The following drawings are merely examples for illustrative purposes according to various disclosed embodiments and are not intended to limit the scope of the present disclosure.

FIG. 1 is a flowchart of a control method according to an embodiment of the present disclosure.

FIG. 2 is a schematic structural diagram of a display screen according to an embodiment of the present disclosure.

FIG. 3 is a schematic diagram of an expanded display screen according to an embodiment of the present disclosure.

FIG. 4 is a schematic diagram of the expanded display screen according to an embodiment of the present disclosure.

FIG. 5 is a schematic diagram of the expanded display screen according to an embodiment of the present disclosure.

FIG. 6 is a schematic diagram of the expanded display screen according to an embodiment of the present disclosure.

FIG. 7 is a schematic structural diagram of an electronic device according to an embodiment of the present disclosure.

FIG. 8 is a schematic structural diagram of another electronic device according to an embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Since the conventional method of controlling the expansion/contraction of a deformable display screen can only expand/contract at a fixed speed, the user experience is affected. Therefore, to improve the user experience, the present disclosure provides a control method and an electronic device. The electronic device provided by the present disclosure may be a device equipped with a deformable display screen, such as a mobile phone and a tablet computer. Deformable display screen may include rollable screens and foldable screens.

The technical solutions of the embodiments of the present disclosure will be described below with reference to the accompanying drawings.

FIG. 1 is a flowchart of a control method according to an embodiment of the present disclosure. The method will be described in detail below.

101, obtaining a configuration parameter in response to a control instruction.

In some embodiments, the control instruction may include a first control instruction and a second control instruction. The first control instruction may correspond to a first working state. The first working state may refer to a state in which the driver drives the display screen to unfold. In response to the first control instruction, the electronic device may control the driver to drive the display screen to unfold. The second control instruction may correspond to a second working state. The second working state may refer to a state in which the driver drives the display screen to contract. In response to the second control instruction, the electronic device may control the driver to drive the display screen to contract.

The configuration parameter may include a speed parameter that characterize the movement of the display screen driven by the driver. In some embodiments, when the electronic device responds to the control instruction, the speed corresponding to the motor of the driver may be adjusted based on the control instruction, and the speed may be determined as the configuration parameter. In some embodiments, if the motor arranged in the electronic device is a conventional non-digital motor, such as a DC motor, the speed corresponding to the driver's motor may be configured by adjusting the current and voltage; if the motor arranged in the electronic device is a digital motor, such as a stepper motor or a brushless motor, the corresponding speed of the motor may be configured by adjusting the frequency of the digital pulses.

102, controlling the driver to be in a working state corresponding to the control instruction based on the configuration parameter, the driver being configured to drive the display screen to switch between a first state and a second state based on the configuration parameter being in a working state corresponding to the control instruction.

The display screen in the first state may correspond to a first part of the display screen, the display screen in the second state may correspond to a second part of the display screen, the second part of the display screen including the first part of the display screen.

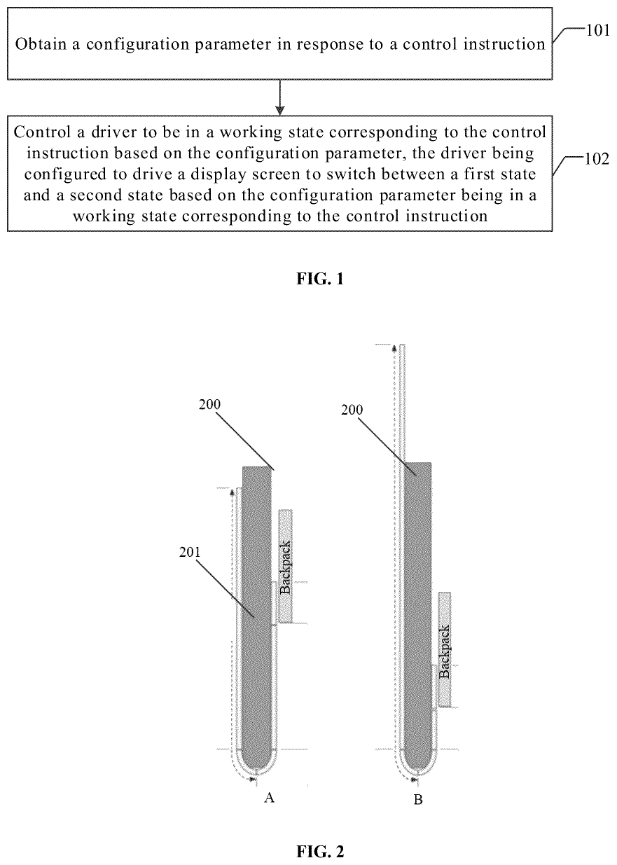

FIG. 2 is a schematic structural diagram of a display screen according to an embodiment of the present disclosure. As shown in FIG. 2, a display screen 201 is arranged on the surface of a body 200 of an electronic device. As shown in FIG. 2A, the display screen 201 can be curled and applied along both sides of the body 200 of the electronic device without exceeding the body 200. As shown in FIG. 2B, the display screen 201 can be unfolded along one side of the body 200 of the electronic device such that the display screen on that side becomes longer.

Take FIG. 2 as an example. If the first state of the display screen is a state where the display screen is flush with the body of the electronic device, the second state of the display screen may be any state where the display screen is expanded beyond the body of the electronic device. If the first state of the display screen is a state where the display screen is contracted to a state smaller than the body of the electronic device, the second state where the display screen may be any state in which the display screen is expanded beyond the body of the electronic device, a state in which the display screen is flush with the body of the electronic device, or a state in which the degree of contraction of the display screen is smaller than the first state. If the first state of the display screen is a state where the display screen is expanded beyond the body of the electronic device but has not yet been fully expanded, the second state of the display screen may be any state where the degree of expansion is greater than the first state. In some embodiments, the first part of the display screen corresponding to when the display screen is in the first state may refer to the part of the display screen corresponding to a target side of the body of the electronic device, and the second part of the display screen corresponding to when the display screen is in the second state may refer to the part of the display screen corresponding to the target side of the body of the electronic device. The target side may refer to the side from which the display screen can be extended. As shown in FIG. 2, the target side of the body of the electronic device can be the left side of the body 200.

In some embodiments, the display screen may also be two sub-display screens arranged on the same side of the body of the electronic device. Any one of the two sub-display screens may be driven by a driver to expand or contract.

In some embodiments, the display screen may also be a foldable display screen disposed on both sides of the body of the electronic device. The foldable display screen can be driven by a driver to expand or contract laterally along the body of the electronic device.

The speed represented by the configuration parameter may be different, and the time it takes for the display screen to switch between the first state and the second may be different. In some embodiments, the configuration parameter may include multiple speed parameters, each speed parameter representing a different speed. In the present disclosure, the configuration parameter obtained by the electronic device in the process of responding to the control instruction may include a plurality of configuration parameters, and each configuration parameter may represent a different speed.

Consistent with the control method of the present disclosure, the electronic device can obtain the configuration parameter in response to the control instruction, and the control the driver to be in a working state corresponding to the control instruction based on the configuration parameter. The driver can drive the display screen to switch between the first state and the second state based on the configuration parameter being in a working state corresponding to the control instruction. By controlling the driver to drive the display screen to switch between the first state and the second state based on the configuration parameter in the working state corresponding to the control instruction, the expansion/contraction speed of the display screen can be adapted to the configuration parameter. When the user wants to quickly expand/contract the display screen, the user can flexibly adjust the switching speed between the first state and the second state by adjusting the configuration parameter such that the display screen can be quickly expanded/contracted. When the user wants to slow down the expansion/contraction speed of the display screen, the user can also change the expansion/contraction speed of the display screen by adjusting the configuration parameter. In this way, the user experience is greatly improved.

In some embodiments, obtaining the configuration parameter may include a process A1, which includes obtaining a plurality of configuration parameters, each configuration parameter characterizing different speeds. Subsequently, controlling the driver to be in a working state corresponding to the control instruction based on the configuration parameter may include: controlling the driver to be in a working state corresponding to the control instruction based on the plurality of configuration parameters, the driver driving the display screen to switch speed between the first state and the second state based on the plurality of configuration parameters being in a working state corresponding to the control instruction.

In the present disclosure, the plurality of configuration parameters corresponding to a plurality of preset speeds may be configured in advance. The speed corresponding to each configuration parameter may be different such that the driver can flexibly adjust the switching speed based on the plurality of configuration parameters when the driver drives the display screen to switch between the first state and the second state. For example, the first state of the display screen may be a state that is flush with the body of the electronic device, and the second state of the display screen may be a state that is fully expanded along the target side of the electronic device. In this way, the pre-configuration may be that when the display screen starts to expand from the first state until the display screen expands to a first preset ration of the full size of the display screen, the expansion speed can be set to a first target speed; after the display screen is expanded to the first preset ration of the full size of the display screen, the expansion speed can be set to a second target speed. The first preset ration may be 50%, 60%, etc., and the first target speed can be set to 50% or 60% of the driver's reference speed. The first target speed can be set to the driver's reference speed or the driver's maximum speed.

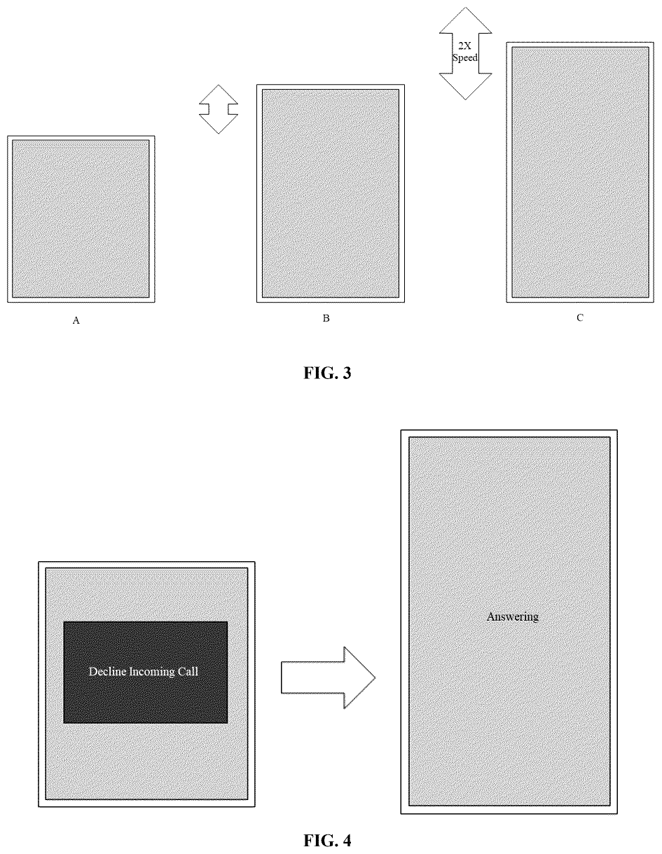

FIG. 3 is a schematic diagram of an expanded display screen according to an embodiment of the present disclosure. As shown in FIG. 3, the electronic device may also configure a plurality of configuration parameters corresponding to two preset speeds. The speed corresponding to the first configuration parameter may be 30% of the full motor speed, and the speed corresponding to the second configuration parameter may be 60% of the full motor speed. That is, the speed corresponding to the second configuration parameter can be two times the speed corresponding to the first configuration parameter. In FIG. 3A, the display screen is flush with the body of the electronic device, and the configuration may be that before the display screen expands from the state shown in FIG. 3A to the first preset ration of the full size of the display screen shown in FIG. 3B, the expansion speed may be set to 30% of the full motor speed; after the display screen expands to the first preset ration of the full size of the display screen, the expansion speed may be set to 60% of the full motor speed. In this way, the driver can drive the display screen to expand from the state shown in FIG. 3B to the state shown in FIG. 3C at 60% of the full motor speed.

In the present disclosure, in the process of responding to the control instruction, the electronic device may also determine a plurality of configuration parameters in real time based on the ambient volume and the power of the electronic device, and each configuration parameter may correspond to a different speed. In this way, the switching speed of the driver driving the display screen to switch between the first state and the second state can be flexibly adjusted based on the plurality of configuration parameters.

In some embodiments, obtaining the configuration parameter in response to the control instruction may include one of process B1 and process B2.

B1, obtaining a target parameter through a target sensing device in response to the control instruction; and determining the configuration parameter corresponding to the target parameter based on the target parameter.

B2, obtaining a first target parameter through the target sensing device in response to the control instruction; determining a first configuration parameter corresponding to the first target parameter based on the first target parameter satisfying a first range; the target sensing device obtaining a second target parameter that satisfies a second range if the driver is controlled to be in a working state corresponding to the control instruction based on the first configuration parameter; and determining a second configuration parameter corresponding to a second target parameter, the second configuration parameter being used to replace the first configuration parameter.

In the present disclosure, the target sensing device may be a microphone (mic) or a power meter. The ambient volume of the environment where the electronic device is located or the power of the electronic device can be monitored through the target sensing device, and the monitored parameters representing the ambient volume or power can be used as the target parameters. The electronic device may adjust the configuration parameters in real time based on the changes in the target parameters, and determine the configuration parameters corresponding to the target parameters. Different configuration parameters may represent different driving speeds, and the driver can be controlled to be in a working state corresponding to the control instruction based on the configuration parameters corresponding to the target parameters. In this way, the driving speed of the driver can be flexibly adjusted based on the ambient volume or power.

In some embodiments, if the target parameter indicates that the ambient volume is greater than a target decibel value, the configuration parameter may represent a first speed; if the target parameter indicates that the ambient volume is not greater than the target decibel value, the configuration parameter may represent a second speed, the first speed being greater than the second speed. In some embodiments, controlling the driver to be in a working state corresponding to the control instruction based on the configuration parameter may include processes C1 and C2.

C1, controlling the driver to be in a working state corresponding to the control instruction based on the configuration parameter if the target parameter indicates the ambient volume is greater than the target decibel value, the driver being configured to drive the display screen to switch between the first state and the second state based on the first speed based on the configuration parameter being in a working state corresponding to the control instruction.

C2, controlling the driver to be in a working state corresponding to the control instruction based on the configuration parameter if the target parameter indicates the ambient volume is not greater than the target decibel value, the driver being configured to drive the display screen to switch between the first state and the second state based on the second speed based on the configuration parameter being in a working state corresponding to the control instruction.

The target decibel value may be set based on the actual application scenario. For example, the target decibel value may be set to 35 decibels, the first speed may be set to the maximum speed of the driver or 80% of the maximum speed of the driver, etc., and the second speed may be set to 40% or 50% of the maximum speed of the driver.

In the present disclosure, since the display screen is driven by the motor of the driver, there is noise when the motor operates, and the greater the speed of the motor, the greater the noise. When the user is in a quiet environment, excessive driving speed will cause the motor to make louder noise, thereby affecting the user's mood. Therefore, when the user is in a quiet environment, the driving speed needs to be reduced to reduce the noise of the motor. On the contrary, in a noisy environment, the noise of the motor will not have an excessive impact on the user. Therefore, when the user is in a noisy environment, the driving speed can be increased and the display screen can be quickly expanded/contracted. In some embodiments, when the ambient volume is lower than the preset decibel (the preset decibel may refer to the corresponding ambient volume when the environment is extremely quiet and the user may be resting), in order to avoid disturbing the user with the sound of the motor operation, the motor operation of the driver may be stopped. In some embodiments, the preset decibel may be set to 25 decibels or 20 decibels.

In some embodiments, if the target parameter indicates that the power of the device is greater than a target power level, the configuration parameter may represent a third speed; if the target parameter indicates that the power of the device is not greater than the target power level, the configuration parameter may represent a fourth speed or a fifth speed, the third speed being greater than the fourth speed, and the fifth speed being greater than the fourth speed. In some embodiments, controlling the driver to be in a working state corresponding to the control instruction based on the configuration parameter may also include at least one of processes D1 and D2.

D1, controlling the driver to be in a working state corresponding to a first control instruction based on the configuration parameter if the target parameter indicates that the power of the device is greater than the target power level, the driver being configured to drive the display screen to switch between the first state and the second state based on the third speed based on the configuration parameter being in a working state corresponding to the control instruction.

D2, controlling the driver to be in a working state corresponding to the first control instruction based on the configuration parameter if the target parameter indicates that the power of the device is not greater than the target power level, the driver being configured to drive the display screen to switch between the first state and the second state based on the fourth speed based on the configuration parameter being in a working state corresponding to the first control instruction; or, controlling the driver to be in a working state corresponding to a second control instruction based on the configuration parameter if the target parameter indicates that the power of the device is not greater than the target power level, the driver being configured to drive the display screen to switch between the first state and the second state based on the fifth speed based on the configuration parameter being in a working state corresponding to the second control instruction.

In this embodiment, the first control instruction may correspond to a first working state, that is, the working state in which the driver drives the display screen to expand, and the second control instruction may correspond to a second working state, that is, the working state in which the driver drives the display screen to contract. The target power level may be set to 60% or 70% of the maximum power of the battery of the electronic device, the third speed may be set to the maximum driving speed or 95% of the maximum driving speed, fourth speed may be set to 75% or 60% of the maximum driving speed, and the fifth speed may be set to the maximum driving speed or 95% of the maximum driving speed.

The driving speed will have an impact on the efficiency of the motor system. Generally, the greater the driving speed, the lower the efficiency of the motor system. Lower efficiency means that expanding the display screen will consume more power, resulting in greater resource consumption.

For the purpose of saving resources, when the driver drives the display screen to expand, the corresponding driving speed can be adjusted based on the battery power of the electronic device. When the battery is low, the driving speed of the driver can be reduced to save the power consumed when expanding the display screen. When the battery is high, resources are sufficient, and the driving speed of the driver can be increased, allowing the display screen to be expanded quickly. For example, if the target power level is set to 60% of the maximum power of the electronic device's battery, when the electronic device's battery power is greater than 60% of the maximum power, the battery power is relatively sufficient, and the driver can drive the display screen at the maximum driving speed. When the battery power of the electronic device is less than or equal to 60% of the maximum power, the battery power is relatively low. In order to save power, the expansion speed of the display screen can slow down, and the driver can drive the display screen to expand at 75% of the maximum driving speed. In some embodiments, when the battery power of the electronic device is less than or equal to 60% of the maximum power, if the current power of the battery is greater than 30% of the maximum power of the battery and less than 60% of the maximum power of the battery, the driver can drive the display screen to expand at 75% of the maximum driving speed; if the current power of the battery is greater than 10% of the maximum power of the battery and less than or equal to 30% of the maximum power of the battery driver can drive the display screen to expand at 50% of the maximum driving speed; if the current power of the battery is less than or equal to 10% of the maximum power of the battery, it means that the current power is extremely low, and the driving speed of the driver needs to be further slowed down to save power for other important functions of the electronic device, the driver can drive the display screen to expand at 10% of the maximum driving speed, or, in order to save power the driver's motor can be stopped directly.

Since the display screen exposed outside the body of the electronic device is easily damaged by collision, when the driver drives the display screen to contract, for the safety of the display screen, no matter whether the battery power of the electronic device is high or low, the driver needs to drive the display screen to contract quickly to prevent the display screen exposed outside the body of the electronic device from being damaged due to the delay in retracting the display screen in time during the contraction process. For example, if the target power level is set to 60% of the maximum power of the electronic device's battery, when the electronic device's battery power is greater than 60% of the maximum power, the battery power is relatively sufficient, and the driver can drive the display screen to contract based on the maximum driving speed. When the battery power of the electronic device is less than or equal to 60% of the maximum power, the battery power is relatively low. In order to promptly retract the display screen exposed outside the electronic device body and avoid the display screen from being damaged due to failure to retract the display screen, the driver's motor still needs to pre-rotate at high speed. That is, the driver can drive the display screen to contract at the maximum driving speed or 95% of the maximum driving speed.

In some embodiments, obtaining the configuration parameter in response to the control instruction may include obtaining at least one configuration parameter included in the control instruction in response to the control instruction. In the present disclosure, the control instruction may include parameters characterizing the driving speed, and the parameters characterizing the driving speed in the control instruction may be used as configuration parameters. The control instruction may include one or more configuration parameters characterizing the driving speed.

In some embodiments, the control instruction may be a call acceptance instruction, a content display instruction, etc. For example, if the electronic device is a mobile phone, when there is an incoming call, if the user answers the call, it means that the electronic device has received the call acceptance instruction. When the mobile phones detects that the application software needs to display text or image content on the display screen, it means that the electronic device has received the content display instruction.

In some embodiments, the control instruction may be a call acceptance instruction. The call acceptance instruction may include a target configuration parameter, and the target configuration parameter may represent a speed higher than a reference speed. Subsequently, controlling the driver to be in a working state corresponding to the control instruction based on the configuration parameter may include the process at E1.

E1, controlling the driver to be in a working state corresponding to the call acceptance instruction based on the target configuration parameter, the driver being configured to drive the display screen from the first state corresponding to the first part of the display screen based on the target configuration parameter being in the first working state corresponding to the call acceptance instruction to extend the display screen in the second state corresponding to the second part of the display screen along the long edge of the display screen.

In some embodiments, the reference speed may be set based on the usage of the electronic device. For example, the reference speed may be set to 80% or 90% of the maximum driving speed. The motor generally drives the display screen to expand/contract based on the reference speed. The maximum driving speed may refer to the corresponding driving speed when the motor is running at full power.

When the electronic device receives an incoming call notification, the user can choose whether to answer the call. For example, the user can choose to answer the call by clicking on the call acceptance indication on the display screen or by pressing a button. The use can also choose to answer the call by executing a preset call acceptance indication action. Choosing the answer an incoming call indicates that the call acceptance instruction is triggered. The call acceptance instruction may include a target configuration parameter, and the target configuration parameter may include a driving speed.

In the present disclosure, for the display screen that expands/contracts vertically along both sides of the electronic device body as shown in FIG. 2, it is in a portrait mode after expansion. The size of the electronic device can be expanded by expanding the display screen, making it easier for the user to answer calls. Therefore, for this type of display screen, the electronic device can determine the target configuration parameters based on the call acceptance instruction after receiving the call acceptance instruction. That is, the driving speed of the driver can be determined based on the target configuration parameters. The driving speed may be higher than the reference speed such that the display screen can be quickly expanded to facilitate the user to answer the phone. For example, the driving speed can be the maximum driving speed, and the electronic device can control the driver to drive the display screen to expand based on the maximum driving speed, and make the display screen expand from the first part corresponding to the first state to the long edge of the display screen of the second part corresponding to the second state. The first state of the display screen may refer to a state in which the display screen is not expanded or not fully expanded, and the second state of the display screen may refer to a state in which more screens are expanded than in the first state. As shown in FIG. 2, the display screen is attached to both sides of the electronic device body 200. In FIG. 2A and FIG. 2B, the part of the display screen on the left side of the electronic device body is the long side of the display screen. for this type of display screen, since the long edge is easier to expand, when accepting a call notification, the display screen can be quickly expanded along the long edge to the second part of the display screen corresponding to the second state. That is, the exposed size of the display screen can be quickly lengthened such that the expanded display size is convenient for users to answer calls and hold the electronic device when answering calls, thereby improving the user experience of answering calls. FIG. 4 is a schematic diagram of the expanded display screen according to an embodiment of the present disclosure. As shown in FIG. 4, when the electronic device receives an incoming call notification, if the user chooses “decline incoming call”, the display screen will remain in its original state without expansion. Alternatively, if the user chooses to answer the call, the display screen can be quickly expanded from the state shown on the left side of FIG. 4 to the state shown on the right side of FIG. 4 to facilitate the user to answer the call.

In the present disclosure, for a display screen that expands/contracts laterally along both sides of the electronic device body, it is in a landscape mode after expansion. The landscape mode is not suitable for users to hold the electronic device when answering calls, therefore, expansion may affect the user's experience of answering calls. For the landscape mode, the first state of the display screen may refer to a state in which the display screen is fully expanded or not fully expanded, and the second state of the display screen may refer to a state in which the display screen is flush with or lower than the body of the electronic device. Based on this, for this type of laterally expanded/contracted display screen, after the electronic device receives the call acceptance instruction, the electronic device can maintain the current state if the display screen is in a contracted state, and determine the target configuration parameter based on the call acceptance instruction if the display screen is in an expanded state. That is, the driving speed of the driver can be determined based on the target configuration parameter. The driving speed can be higher than the reference speed to make the display screen contract quickly to facilitate the user to answer the call. For example, the driving speed can be the maximum driving speed, and the electronic device can control the driver to drive the display screen to contract to the second state along the short edge of the display screen based on the maximum driving speed. In this way, the contracted display screen size will be easier for users to answer calls and hold the electronic device when answering calls, thereby improving the user experience of answering calls.

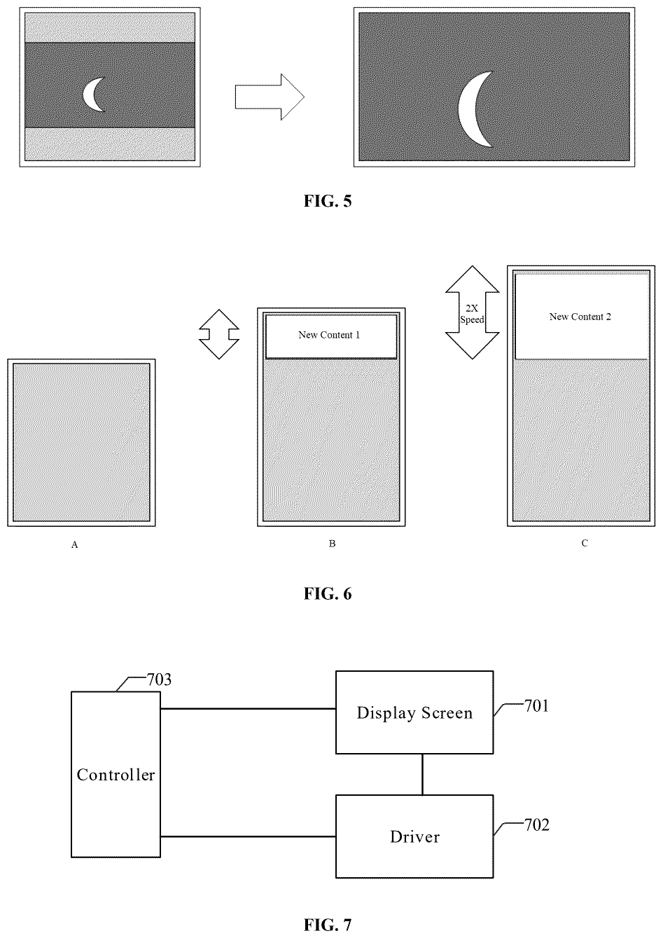

FIG. 5 is a schematic diagram of the expanded display screen according to an embodiment of the present disclosure. As shown in FIG. 5, when the electronic device receives an instruction to enlarge the display screen size, that is, the control instruction is a display screen enlargement instruction, the display screen enlargement instruction may include the target configuration parameter, and the speed represented by the target configuration parameter may be lower than the reference speed. Subsequently, controlling the driver to be in a working state corresponding to the control instruction based on the configuration parameter may include: controlling the driver to be in a working state corresponding to the display screen enlargement instruction based on the target configuration parameter. The driver may drive the display screen in the first state corresponding to the first part of the display screen based on the target configuration parameter being in the first working state corresponding to the display screen enlargement instruction to the display screen in the second state corresponding to the second part of the display screen extending with the long edge of the display screen. When the electronic device receives an instruction to enlarge the display screen size, the target configuration parameter can be determined based on the instruction to enlarge the display screen size. That is, the driving speed of the driver can be determined based on the target configuration parameter, and the driving speed can be lower than the reference speed to slowly expand the display screen. In this way, the display screen can be enlarged to the maximum size for video playback to allow a smooth transition of the displayed content. As shown in FIG. 5, slowly expanding the display screen based on the driving speed can smoothly expand the content of the rectangular area displayed on the left side FIG. 5 to the content shown on the right side of FIG. 5. In some embodiments, the driving speed may be 50% or 60% of the maximum driving speed.

In some embodiments, the control instruction may be a content display instruction. The content display instruction may include the target configuration parameter, and the target configuration parameter may be determined based on the data size of the content. Subsequently, controlling the driver to be in a working state corresponding to the control instruction based on the configuration parameter may include the process at F1.

F1, controlling the driver to be in a working state corresponding to the content display instruction based on the target configuration parameter, the driver being configured to drive the display screen in the first state corresponding to the first part of the display screen based on the target configuration parameter being in the first working state corresponding to the content display instruction to the display screen in the second state corresponding to the second part of the display screen extending with the long edge of the display screen.

In some embodiments, the switching time from when the display screen is in the first state corresponding to the first part of the display screen wo when the display screen is in the second state corresponding to the second part of the display screen may be the same, and different amounts of data may correspond to target configuration parameters representing different speeds.

In some embodiments, the display content may be text, images, etc. The amount of display content to be displayed can be obtained. The content display time can be fixed, then the amount of content to be displayed per nit time can be determined based on the amount of displayed content and the display time. Subsequently, the target size corresponding to the amount of content to be displayed per unit time can be determined, thereby determining that the size of the display screen expanded within the unit time is not less than the target size to ensure that the displayed content can be continuously displayed on the display screen. The target configuration parameters corresponding to the display contents of different amounts of data may represent different driving speeds. The greater the amount of data, the greater the driving speed such that the display content can be continuously displayed on the display screen.

In some embodiments, if the amount of data being displayed increases during the display process, the driving speed must be adjusted in real time to ensure that the displayed content can be continuously displayed on the display screen.

FIG. 6 is a schematic diagram of the expanded display screen according to an embodiment of the present disclosure. As shown in FIG. 6, FIG. 6A shows the first state of the display screen, FIG. 6B shows that when the amount of content is “New Content 1”, the driver drives the display screen to expand from the first state to the corresponding second state within a specified time t, and FIG. 6C shows that the second state corresponding to the display screen expanded from the first state within the specified time t when the amount of content is “New Content 2”. The amount of content of “New Content 2” is twice the amount of content of “New Content 1”. When the expansion time is the same as t, if “New Content 2” needs to be displayed on the expanded display screen, the driver in FIG. 6C needs to drive the display screen to expand at twice the speed.

In some embodiments, the displayed content may also be a dialog box popped up by a chat software. For this scenario, the first state of the display screen corresponding to the boundary of the first part of the display screen may not be fixed, but updated in real time. Each time a chat box pops up, the boundary of the currently displayed display screen can be determined as the boundary of the first part of the display screen. In this way, the electronic device can adjust the driving speed in real time based on the first part and the second part of the display screen and the content included in the chat box, thereby ensuring that each pop-up chat box can be displayed on the display screen.

In some embodiments, the configuration parameters may be determined based on the number of target input operations obtained through the input device per unit time before the control instruction is generated. In some embodiments, the greater the target input operations, the greater the speed represented by the configuration parameters.

In some embodiments, the corresponding configuration parameter may be determined based on the frequency of user input operations on the electronic device. The user input operations on the electronic device may include typing and pressing buttons on an e-book. The greater the frequency of the user input operations on the electronic device, the greater the speed represented by the configuration parameter. For example, if the number of words typed by the user in unit time reaches a first preset number, the driving speed in the configuration parameter may be set to the maximum driving speed, and the driver may be controlled to expand/contract the display screen based on the maximum driving speed. If the number of words typed by the user in unit time reaches a second preset number, the driving speed in the configuration parameter may be set to 80% of the maximum driving speed, and the driver may be controlled to expand/contract the display screen at 80% of the maximum driving speed. In some embodiments, the first preset number may be set to 200 or 250, the second preset number may be set to 150 or 180, and the unit time may be one minute. In another example, if the user clicks the “Enter” button at a speed that reaches a first preset speed, the driving speed in the configuration parameter may be set to the maximum driving speed, and the driver may be controlled to expand/contract the display screen based on the maximum driving speed. If the user clicks the “Enter” button at a speed that reaches a second preset speed, the driving speed in the configuration parameter may be set to 80% of the maximum driving speed, and the driver ma be controlled to expand/contract the display screen at 80% of the maximum driving speed. The first preset speed and the second preset speed may be set based on the actual application scenario, and the first preset speed may be greater than the second preset speed.

In some embodiments, the display screen of the electronic device may include a speed setting area. The user may click the speed setting area to set the desired driving speed as a configuration parameter such that the electronic device can control the driver to expand/contract the display screen based on the driving speed. In other embodiments, the settings of the electronic device may include speed setting buttons. Different buttons may represent different driving speeds. The user may set the desired driving speed as a configuration parameter by clicking the button such that the electronic device can control the driver to expand/contract the display screen based on the driving speed.

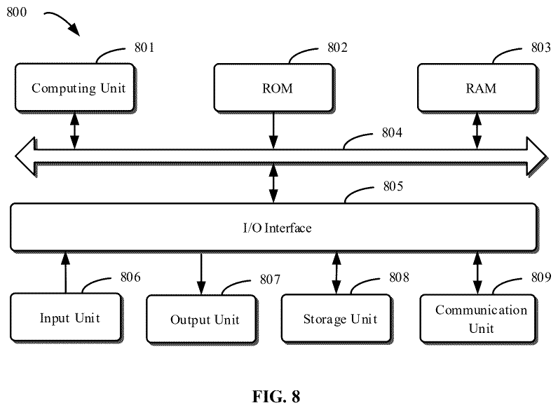

Another aspect of the present disclosure also provides an electronic device. FIG. 7 is a schematic structural diagram of an electronic device according to an embodiment of the present disclosure. As shown in FIG. 7, the electronic device includes a deformable display screen 701, a driver 702, and a controller 703. The first state of the deformable display screen may correspond to the first part of the deformable display screen, and the second state of the deformable display screen may correspond to the second part of the deformable display screen, the second part of the deformable display screen including the first part of the deformable display screen. The driver 702 may be configured to drive the deformable display screen to switch between the first state and the second state. The controller 703 may be configured to respond to a control instruction, the control instruction including a configuration parameter characterizing the speed; and, control the driver based on the configuration parameter such that the driver is in a working state based on the configuration parameter. In some embodiments, the driver may be in a working state based on different configuration parameters, and the deformable display screen may switch between the first state and the second state at different speeds.

Consistent with the present disclosure, the electronic device can obtain the configuration parameter in response to the control instruction, and the control the driver to be in a working state corresponding to the control instruction based on the configuration parameter. The driver can drive the display screen to switch between the first state and the second state based on the configuration parameter being in a working state corresponding to the control instruction. By controlling the driver to drive the display screen to switch between the first state and the second state based on the configuration parameter in the working state corresponding to the control instruction, the expansion/contraction speed of the display screen can be adapted to the configuration parameter. When the user wants to quickly expand/contract the display screen, the user can flexibly adjust the switching speed between the first state and the second state by adjusting the configuration parameter such that the display screen can be quickly expanded/contracted. When the user wants to slow down the expansion/contraction speed of the display screen, the user can also change the expansion/contraction speed of the display screen by adjusting the configuration parameter. In this way, the user experience is greatly improved.

In some embodiments, the electronic device may also include a body. The first state of the deformable display screen may correspond to the first part of the deformable display screen being located within a first surface of the body; the second state of the deformable display screen may correspond to the second part of the deformable display screen located on the first surface of the body and beyond the first surface. The driver may be used to drive the deformable display screen to move relative to the body and switch between the first state and the second state.

Alternatively, the electronic device may also include a first body and a second body. When the first body and the second body are in a first relative position, the deformable display screen may be in the first state; when the first body and the second body are in a second relative position, the deformable display screen may be in the second state. The driver may be used to drive the first body and the second body to switch between the first relative position and the second relative position such that the deformable display screen can switch between the first state and the second state.

In some embodiments, the electronic device may include only one body. The body of the electronic device may refer to the main structure of the electronic device that can carry a deformable display screen. The body of the electronic device generally includes components such as a screen bottom plate, a flexible display layer, a protective layer, and a support structure.

In some embodiments, the electronic device may also include the first body and the second body. When the first body and the second body are in the first relative position, the deformable display screen may be in the first state of being flush with the body or retracting back into the body. When the first body and the second body are in the second relative position, the deformable display screen may be in a fully expanded or partially expanded second state.

In some embodiments, the controller 703 may be further configured to respond to the control instruction. The control instruction may include a plurality of configuration parameters, and each of the plurality of configuration parameters may represent a different speed. The controller 703 may be further configured to control the driver to be in a working state corresponding to the control instruction based on the plurality of configuration parameters. The driver may drive the display screen to switch between the first state and the second state based on the plurality of configuration parameters being in a working state corresponding to the control instruction.

In some embodiments, the controller 703 may be further configured to obtain the target parameter through the target sensing device in response to the control instruction, and obtain the configuration parameter corresponding to the target parameter based on the target parameter; or, obtain the first target parameter through the target sensing device in response to the control instruction, and determine the first configuration parameter corresponding to the first target parameter based on the first target parameter satisfying the first range. The target sensing device may obtain the second target parameter that satisfies the second range if the driver is controlled to be in a working state corresponding to the control instruction based on the first configuration parameter; and determine the second configuration parameter corresponding to the second target parameter, the second configuration parameter being used to replace the first configuration parameter.

In some embodiments, if the target parameter indicates that the ambient volume is greater than a target decibel value, the configuration parameter may represent a first speed; if the target parameter indicates that the ambient volume is not greater than the target decibel value, the configuration parameter may represent a second speed, the first speed being greater than the second speed. The controller 703 may be further configured to control the driver to be in a working state corresponding to the control instruction based on the configuration parameter if the target parameter indicates the ambient volume is greater than the target decibel value, the driver being configured to drive the display screen to switch between the first state and the second state based on the first speed based on the configuration parameter being in a working state corresponding to the control instruction.

In some embodiments, the controller may be further configured to control the driver to be in a working state corresponding to the control instruction based on the configuration parameter if the target parameter indicates the ambient volume is not greater than the target decibel value, the driver being configured to drive the display screen to switch between the first state and the second state based on the second speed based on the configuration parameter being in a working state corresponding to the control instruction.

In some embodiments, if the target parameter indicates that the power of the device is greater than a target power level, the configuration parameter may represent a third speed; if the target parameter indicates that the power of the device is not greater than the target power level, the configuration parameter may represent a fourth speed or a fifth speed, the third speed being greater than the fourth speed, and the fifth speed being greater than the fourth speed.

In some embodiments, the controller 703 may be further configured to control the driver to be in a working state corresponding to the first control instruction based on the configuration parameter if the target parameter indicates that the power of the device is greater than the target power level, the driver being configured to drive the display screen to switch between the first state and the second state based on the third speed based on the configuration parameter being in a working state corresponding to the control instruction.

In some embodiments, the controller 703 may be further configured to control the driver to be in a working state corresponding to the first control instruction based on the configuration parameter if the target parameter indicates that the power of the device is not greater than the target power level, the driver being configured to drive the display screen to switch between the first state and the second state based on the fourth speed based on the configuration parameter being in a working state corresponding to the first control instruction; or, control the driver to be in a working state corresponding to the second control instruction based on the configuration parameter if the target parameter indicates that the power of the device is not greater than the target power level, the driver being configured to drive the display screen to switch between the first state and the second state based on the fifth speed based on the configuration parameter being in a working state corresponding to the second control instruction.

In some embodiments, the controller 703 may be further configured to obtain at least one configuration parameter included in the control instruction based on the control instruction.

In some embodiments, the control instruction may be a call acceptance instruction. The call acceptance instruction may include a target configuration parameter, and the target configuration parameter may represent a speed higher than the reference speed.

In some embodiments, the controller 703 may be further configured to control the driver to be in a working state corresponding to the call acceptance instruction based on the target configuration parameter, the driver being configured to drive the display screen from the first state corresponding to the first part of the display screen based on the target configuration parameter being in the first working state corresponding to the call acceptance instruction to extend the display screen in the second state corresponding to the second part of the display screen along the long edge of the display screen.

In some embodiments, the control instruction may be a content display instruction. The content display instruction may include the target configuration parameter, and the target configuration parameter may be determined based on the data size of the content.

In some embodiments, the controller 703 may be further configured to control the driver to be in a working state corresponding to the content display instruction based on the target configuration parameter, the driver being configured to drive the display screen in the first state corresponding to the first part of the display screen based on the target configuration parameter being in the first working state corresponding to the content display instruction to the display screen in the second state corresponding to the second part of the display screen extending with the long edge of the display screen.

In some embodiments, the switching time from when the display screen is in the first state corresponding to the first part of the display screen wo when the display screen is in the second state corresponding to the second part of the display screen may be the same, and different amounts of data may correspond to target configuration parameters representing different speeds.

In some embodiments, the configuration parameters may be determined based on the number of target input operations obtained through the input device per unit time before the control instruction is generated. In some embodiments, the greater the target input operations, the greater the speed represented by the configuration parameters.

According to the embodiments of the present disclosure, the present disclosure also provides an electronic device and a computer-readable storage medium.

FIG. 8 is a schematic structural diagram of an electronic device 800 according to an embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 8, the electronic device 800 includes a computing unit 801, which may perform various appropriate actions and processing according to a computer program stored in a read-only memory (ROM) 802 or a computer program loaded from a storage unit 808 to a random-access memory (RAM) 803. The RAM 803 may further store various programs and data required for the operation of the electronic device 800. The computing unit 801, the ROM 802, and the RAM 803 are connected to each other through a bus 804. An input/output (I/O) interface 805 is also connected to the bus 804.

A plurality of components in the electronic device 800 are connected to the I/O interface 805, including: an input unit 806, an output unit 807, the storage unit 808, and a communication unit 809. The input unit 806 may be any type of device capable of entering information to the electronic device 800. The input unit 806 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 807 may be any type of device capable of presenting information, and may include, but is not limited to, a display, a speaker, a video/audio output terminal, a vibrator, and/or a printer. The storage unit 808 may include, but is not limited to, a magnetic disk and an optical disc. The communication unit 809 allows the electronic device 800 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, an 802.11 device, a Wi-Fi device, a WiMAX device, a cellular communication device, and/or the like.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 801 performs the various methods and processing described above, for example, the control method. For example, in some embodiments, the control method may be implemented as a computer software program, which is tangibly contained in a machine-readable medium, such as the storage unit 808. In some embodiments, a part or all of the computer program may be loaded and/or installed onto the electronic device 800 via the ROM 802 and/or the communication unit 809. When the computer program is loaded onto the RAM 803 and executed by the computing unit 801, one or more steps of the control method can be performed. Alternatively, in other embodiments, the computing unit 801 may be configured, by any other suitable means (for example, by means of firmware), to perform the control method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

In addition, the terms “first” and “second” are used for descriptive purposes only and should not be understood as indicating or implying relative importance or implicitly indicate the number of technical features indicated. Thus, a feature described with “first” or “second” may include one or more of such features explicitly or implicitly. In the description of the present disclosure, “plurality of” means two or more, unless otherwise specified.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A control method comprising:
obtaining a configuration parameter in response to a control instruction; and
controlling a driver to be in a working state corresponding to the control instruction based on the configuration parameter, the driver being configured to drive a display screen to switch between a first state and a second state based on the configuration parameter being in the working state corresponding to the control instruction; the display screen being in the first state corresponds to a first part of the display screen, and the display screen being in the second state corresponds to a second part of the display screen, the second part including the first part, wherein
the speed represented by the configuration parameter is different, and a time for the display screen to switch between the first state and the second state is different.

2. The control method of claim 1, wherein obtaining the configuration parameter includes:
obtaining a plurality of configuration parameters, each of the plurality of configuration parameters representing different speeds; and
controlling the driver to be in the working state corresponding to the control instruction based on the configuration parameter includes:
controlling the driver to be in the working state corresponding to the control instruction based on the plurality of configuration parameters, the driver being configured to drive the display screen to switch between the first state and the second state based on the plurality of configuration parameters being in the working state corresponding to the control instruction.

3. The control method of claim 1, wherein obtaining the configuration parameter in response to the control instruction includes:
obtaining, by a target sensing device, a target parameter in response to the control instruction; and
determining the configuration parameter corresponding to the target parameter based on the target parameter; or,
obtaining, by the target sensing device, a first target parameter in response to the control instruction;
determining a first configuration parameter corresponding to the first target parameter based on the first target parameter satisfying a first range; and
obtaining, by the target sensing device, a second target parameter that satisfies a second range, and determining a second configuration parameter corresponding to the second target parameter, the second configuration parameter being used to replace the first configuration parameter.

4. The control method of claim 3, wherein:
the configuration parameter represents a first speed if the target parameter indicates an ambient volume is greater than a target decibel value; the configuration parameter represents a second speed if the target parameter indicates that the ambient volume is less than or equal to the target decibel value, the first speed being greater than the second speed; and
controlling the driver to be in the working state corresponding to the control instruction based on the configuration parameter includes:
controlling the driver to be in the working state corresponding to the control instruction based on the configuration parameter if the target parameter indicates that the ambient volume is greater than the target decibel value, the driver being configured to drive the display screen to switch between the first state and the second state based on the first speed based on the configuration parameter being in the working state corresponding to the control instruction;
controlling the driver to be in the working state corresponding to the control instruction based on the configuration parameter if the configuration parameter indicates that the ambient volume is less than or equal to the target decibel value, the driver being configured to drive the display screen to switch between the first state and the second state based on the second speed based on the configuration parameter being in the working state corresponding to the control instruction.

5. The control method of claim 3, wherein:
the configuration parameter represents a third speed if the target parameter indicates that a device power is greater than a target power level; the configuration parameter represents a fourth speed or a fifth speed if the target parameter indicates that the device power is less than or equal to the target power level, the third speed being greater than the fourth speed, the fifth speed being greater than the fourth speed; and
controlling the driver to be in the working state corresponding to the control instruction based on the configuration parameter includes:
controlling the driver to be in the working state corresponding to a first control instruction based on the configuration parameter if the target parameter indicates that the device power is greater than the target power level, the driver being configured to drive the display screen to switch between the first state and the second state based on the third speed based on the configuration parameter being in the working state corresponding to the first control instruction;
controlling the driver to be in the working state corresponding to the first control instruction based on the configuration parameter if the target parameter indicates that the device power is less than or equal to the target power level, the driver being configured to drive the display screen to switch between the first state and the second state based on the fourth speed based on the configuration parameter being in the working state corresponding to the first control instruction; or,
controlling the driver to be in the working state corresponding to a second control instruction based on the configuration parameter if the target parameter indicates that the device power is less than or equal to the target power level, the driver being configured to drive the display screen to switch between the first state and the second state based on the fifth speed based on the configuration parameter being in the working state corresponding to the second control instruction.

6. The control method of claim 1, wherein obtaining the configuration parameter in response to the control instruction includes:
obtaining at least one configuration parameter included in the control instruction in response to the control instruction.

7. The control method of claim 6, wherein:
the control instruction is a call acceptance instruction, the call acceptance instruction including a target configuration parameter, and the speed represented by the target configuration parameter being higher than a reference speed;
controlling the driver to be in the working state corresponding to the control instruction based on the configuration parameter includes:
controlling the driver to be in the working state corresponding to the call acceptance instruction based on the target configuration parameter, the driver being configured to drive the display screen in the first state corresponding to the first part of the display screen to the display screen in the second state corresponding to the second part of the display screen to extend along a long edge of the display screen based on the target configuration parameter being in a first working state corresponding to the call acceptance instruction; or,
the control instruction is a content display instruction, the content display instruction including the target configuration parameter, the target configuration parameter being determined based on content data amount;
controlling the driver to be in the working state corresponding to the control instruction based on the configuration parameter includes:
controlling the driver to be in the working state corresponding to the content display instruction based on the target configuration parameter, the driver being configured to drive the display screen in the first state corresponding to the first part of the display screen to the display screen in the second state corresponding to the second part of the display screen to extend along a long edge of the display screen based on the target configuration parameter being in a first working state corresponding to the content display instruction, wherein:
a switching time between when the display screen is in the first state corresponding to the first part of the display screen and when the display screen is in the second state corresponding to the second part of the display screen is the same, and different content data amounts correspond to target configuration parameters representing different speeds.

8. The control method of claim 1 further comprising:
determining the configuration parameter based on a number of target input operations obtained through an input device per unit time before the control instruction is generated, wherein:
the greater the number of target input operations, the greater the speed represented by the configuration parameter.

9. An electronic device comprising:
a deformable display screen, a first state of the deformable display screen corresponding to a first part of the deformable display screen, a second state of the deformable display screen corresponding to a second part of the deformable display screen, the second part including the first part;
a driver, the driver being configured to drive the deformable display screen to switch between the first state and the second state; and
a controller, the controller being configured to:
respond to a control instruction, the control instruction including a configuration parameter indicating speed; and
control the driver based on the configuration parameter for the driver to be in a working state based on the configuration parameter, wherein:
the driver is in the working state based on different configuration parameters, and the deformable display screen is configurated to switch between the first state and the second state at different speeds.

10. The electronic device of claim 9 further comprising:
a body, the first state of the deformable display screen corresponding to the first part of the deformable display screen being located within a first surface of the body, the second state of the deformable display screen corresponding to the second part of the deformable display screen being located on the first surface of the body and beyond the first surface, the driver being configured to drive the deformable display screen to move relative to the boy and switch between the first state and the configuration parameter; or,
a first body; and
a second body, the deformable display screen being in the first state when the first body and the second body are in a first relative position, the deformable display screen being in the second state when the first body and the second body are in a second relative position, the driver being configured to drive the first body and the second body to switch between the first relative position and the second relative position to cause the deformable display screen to switch between the first state and the second state.

11. The electronic device of claim 9, wherein the controller is further configured to:
respond to the control instruction, the control instruction a plurality of configuration parameters, each of the plurality of configuration parameters representing different speeds; and
control the driver to be in the working state corresponding to the control instruction based on the plurality of configuration parameters, the driver being configured to drive the display screen to switch between the first state and the second state based on the plurality of configuration parameters being in the working state corresponding to the control instruction.

12. The electronic device of claim 9, wherein the controller is further configured to:
obtain a target parameter through a target sensing device in response to the control instruction; and
determine the configuration parameter corresponding to the target parameter based on the target parameter; or,
obtain a first target parameter through the target sensing device in response to the control instruction;
determine a first configuration parameter corresponding to the first target parameter based on the first target parameter satisfying a first range; and
obtain a second target parameter that satisfies a second range through the target sensing device, and determine a second configuration parameter corresponding to the second target parameter, the second configuration parameter being used to replace the first configuration parameter.

13. The electronic device of claim 12, wherein:
the configuration parameter represents a first speed if the target parameter indicates an ambient volume is greater than a target decibel value; the configuration parameter represents a second speed if the target parameter indicates that the ambient volume is less than or equal to the target decibel value, the first speed being greater than the second speed; and
the controller is further configured to:
control the driver to be in the working state corresponding to the control instruction based on the configuration parameter if the target parameter indicates that the ambient volume is greater than the target decibel value, the driver being configured to drive the display screen to switch between the first state and the second state based on the first speed based on the configuration parameter being in the working state corresponding to the control instruction;
control the driver to be in the working state corresponding to the control instruction based on the configuration parameter if the configuration parameter indicates that the ambient volume is less than or equal to the target decibel value, the driver being configured to drive the display screen to switch between the first state and the second state based on the second speed based on the configuration parameter being in the working state corresponding to the control instruction.

14. The electronic device of claim 12, wherein:
the configuration parameter represents a third speed if the target parameter indicates that a device power is greater than a target power level; the configuration parameter represents a fourth speed or a fifth speed if the target parameter indicates that the device power is less than or equal to the target power level, the third speed being greater than the fourth speed, the fifth speed being greater than the fourth speed; and
the controller is further configured to:
control the driver to be in the working state corresponding to a first control instruction based on the configuration parameter if the target parameter indicates that the device power is greater than the target power level, the driver being configured to drive the display screen to switch between the first state and the second state based on the third speed based on the configuration parameter being in the working state corresponding to the first control instruction;
control the driver to be in the working state corresponding to the first control instruction based on the configuration parameter if the target parameter indicates that the device power is less than or equal to the target power level, the driver being configured to drive the display screen to switch between the first state and the second state based on the fourth speed based on the configuration parameter being in the working state corresponding to the first control instruction; or,
control the driver to be in the working state corresponding to a second control instruction based on the configuration parameter if the target parameter indicates that the device power is less than or equal to the target power level, the driver being configured to drive the display screen to switch between the first state and the second state based on the fifth speed based on the configuration parameter being in the working state corresponding to the second control instruction.

15. The electronic device of claim 9, wherein the controller is further configured to:
obtain at least one configuration parameter included in the control instruction in response to the control instruction.

16. The electronic device of claim 15, wherein:
the control instruction is a call acceptance instruction, the call acceptance instruction including a target configuration parameter, and the speed represented by the target configuration parameter being higher than a reference speed; and
the controller is further configured to:
control the driver to be in the working state corresponding to the call acceptance instruction based on the target configuration parameter, the driver being configured to drive the display screen in the first state corresponding to the first part of the display screen to the display screen in the second state corresponding to the second part of the display screen to extend along a long edge of the display screen based on the target configuration parameter being in a first working state corresponding to the call acceptance instruction; or,
the control instruction is a content display instruction, the content display instruction including the target configuration parameter, the target configuration parameter being determined based on content data amount; and
the controller is further configured to:
control the driver to be in the working state corresponding to the content display instruction based on the target configuration parameter, the driver being configured to drive the display screen in the first state corresponding to the first part of the display screen to the display screen in the second state corresponding to the second part of the display screen to extend along a long edge of the display screen based on the target configuration parameter being in a first working state corresponding to the content display instruction, wherein:
a switching time between when the display screen is in the first state corresponding to the first part of the display screen and when the display screen is in the second state corresponding to the second part of the display screen is the same, and different content data amounts correspond to target configuration parameters representing different speeds.

17. The electronic device of claim 9, wherein:
the configuration parameter is determined based on a number of target input operations obtained through an input device per unit time before the control instruction is generated, the greater the number of target input operations, the greater the speed represented by the configuration parameter.
